(19) United States
(12) Patent Application Publication
(10) Pub. No.: US 2025/0068905 A1
(43) Pub. Date: Feb. 27, 2025

(54) COMPUTER-IMPLEMENTED METHOD FOR TRAINING A NEURAL NETWORK USING MTL

(71) Applicant: Robert Bosch GmbH, Stuttgart (DE)

(72) Inventor: Jan Mathias Koehler, Leonberg (DE)

(21) Appl. No.: 18/808,236

(22) Filed: Aug. 19, 2024

(30) Foreign Application Priority Data
Aug. 25, 2023 (DE) 10 2023 208 154.7

(51) Int. Cl. G06N 3/08

(52) U.S. Cl. CPC G06N 3/08

(57) ABSTRACT

A computer-implemented method for training a neural network, wherein the network performs multiple tasks and is trained to solve the tasks. The method includes: collecting data as input values; defining the network architecture including multiple subnetworks, wherein each subnetwork performs a task; defining a loss function for each task; determining an overall loss function that summarizes the loss functions of the individual tasks; determining an optimization method for the overall loss function; training the network, wherein the training comprises minimizing the overall loss function, wherein the minimization of the overall loss function is carried out according to the optimization method; providing the neural network; wherein the overall loss function includes a trainable weighting factor and a regularization term for each loss function, wherein the regularization term is minimal for a particular weighting factor.

### CROSS REFERENCE

The present application claims the benefit under 35 U.S.C. § 119 of German Patent Application NO. DE 10 2023 208 154.7 filed on Aug. 25, 2023, which is expressly incorporated herein by reference in its entirety.

### FIELD

The present invention relates to the training of a neural network that processes multiple tasks simultaneously. The neural network is trained for all its tasks simultaneously, which is called multi-task learning (MTL). The present invention is in particular in the field of MTL.

MTL aims at the learning of multiple tasks simultaneously while taking advantage of common underlying features. In contrast to conventional single-task learning, where a model only fulfills a single task, MTL enables information to be shared between different tasks.

The basic idea behind MTL is that tasks in an MTL model are selected so that they can benefit from each other. By training multiple tasks simultaneously, the model can learn a more general representation that goes beyond the specific requirements of a single task. By capturing common features across tasks, the model can achieve better generalization and improve the performance in the individual tasks.

The selection of the tasks to be learned is a crucial step in MTL. The selected tasks should share a common feature space or be able to benefit from each other in order to achieve the desired synergy effect.

An MTL model therefore typically comprises one or more shared layers and separate task-specific layers for each task. The shared layer(s) capture the common features, while the task-specific layers learn specific features for each task.

During training, inputs flow through the network and the weights are adjusted according to the loss functions of the individual tasks. The shared layer(s) enables the exchange of information between tasks, which can lead to improved generalization and learning performance.

The weighting of the individual tasks can be adjusted depending on their importance and difficulty. By setting different weights, certain tasks can be prioritized while others are considered secondary tasks.

Since MTL is prone to overfitting, sharing knowledge between tasks can be considered a form of regularization. The shared layer(s) promote the formation of features that are consistent across different tasks, thus helping to reduce overfitting.

Overfitting occurs when a model learns the training data very well but has difficulty generalizing to new, unknown data. Overfitting occurs in particular when a model too strongly “memorizes” the training data, losing the underlying patterns and relationships. This can happen especially when the model becomes too complex during the training phase and starts to overlearn random variations and noise in the training data, resulting in too tight a fit to the training data and poor generalization to new data. The features or patterns that the model has learned during training may then be too specific to the training data and not representative of the data as a whole.

The advantage of MTL over single-task learning is that it can increase the efficiency of learning, especially in scenarios with limited data for individual tasks. By sharing information between tasks, MTL models can also capture more robust features and improve performance in individual tasks.

To train a model with MTL, for each task a loss function is ascertained, which is then combined to form an overall loss function.

Various approaches to determining the weighting of the individual loss function in multi-task learning are described in the literature. For example, asynchronous back-propagation (AB) with weighted tasks leads to an improvement in the validation data.

A heuristic is used to determine which tasks are updated every time unit (e.g. epoch) and which tasks are only updated every x-th time unit. For example, a task 1 can be updated every epoch, a task 2 every third epoch, and a task 3 every tenth epoch. The idea behind this approach is that some tasks are easy tasks for which the weights need to be updated through back-propagation less frequently. This allows the network to concentrate on training the difficult tasks.

According to the conventional approaches, the epochs in which tasks are updated must be calculated manually. However, this is not scalable if, for example, many tasks are to be trained.

A technical problem that may be solved by the present invention is to find a training method for neural networks with multiple tasks with which the weighting factors are determined automatically.

This problem may be solved by certain features of the present invention.

### SUMMARY

According to a first aspect of the present invention, the problem may be solved by a computer-implemented method for training a neural network, wherein the network performs multiple tasks and is trained to solve the tasks. According to an example embodiment of the present invention, the method comprises the following steps:
collecting data as input values for the network;
defining the network architecture comprising multiple subnetworks, wherein each subnetwork performs a task;
defining a loss function for each task;
determining an overall loss function that summarizes the loss functions of the individual tasks;
determining an optimization method for the overall loss function;
training the network,
wherein the training comprises minimizing the overall loss function,
wherein the minimization of the overall loss function is carried out according to the optimization method;
wherein the overall loss function comprises a trainable weighting factor and a regularization term for each loss function,
wherein the sum of the weighting factors is 1,
wherein the regularization term is minimal for a given weighting factor, and wherein the regularization term is larger for weighting factors larger than the given weighting factor, and wherein the regularization term is larger for weighting factors smaller than the given weighting factor.

In a first step, data must be collected for training. These can be collected in particular on the basis of exemplary processes or created or artificially generated using other methods and simulations. The collected data form an overall dataset, which is broken down into a training dataset and a validation dataset.

The training dataset is used to train the network. That is, the training dataset is propagated through the network until the overall loss function reaches its minimum. The validation dataset is used to test the network after training. This is because it can be checked whether the network has been correctly set to solve the tasks given to it only by testing it with data that the network has not already seen.

However, before the network can be trained, a network architecture must first be defined. Multi-task networks have multiple subnetworks for different tasks, where each subnetwork performs one or more tasks.

The tasks can, for example, be subtasks of an overall task of a network. For example, if a network has the overall task of classifying an object in a video stream, a subnetwork can be designed to check whether there are any objects in the video stream at all. A second subnetwork can then locate found objects and a third network selects the object of greatest interest from the found objects. A fourth subnetwork can then ultimately classify the object. Furthermore, this embodiment can comprise further subnetworks that comprise image processing tasks such as color corrections, sharpening filters, or contrast adjustments.

The architecture of a neural network comprises multiple nodes, neurons, or nodes, arranged in layers. The subnetworks can share one or more layers to solve their tasks with the same initial values. Each subnetwork can then have its own layers that serve only to solve the specific task of the subnetwork.

The architecture of the subnetworks can then be in particular a horizontal, vertical, or combined architecture.

In a horizontal architecture, the subnetworks are arranged side by side. Although the subnetworks access the same predecessor layer, they process the outputs of the predecessor layer independently of each other. The outputs of the subnetworks can then be combined to solve the task of the overall network.

Vertical architectures comprise subnetworks arranged one after the other. This means that the output values of one network are the input values of the next subnetwork. The last subnetwork in this architecture then solves the task of the overall network.

In combined architectures, vertical and horizontal arrangements are combined. This can be illustrated using an example. For example, a network has 5 subnetworks. The first three networks are arranged vertically so that the second network receives the output values of the first network as input values and the third network receives the output values of the second network as input values. A fourth network is coordinate to networks one through three, so that it uses the same input data as the first network. Networks one to three and network four are thus arranged horizontally. A fifth network can in turn receive the output values of the third network and the fourth network as input values, so that the fifth network is arranged vertically to networks one to four. The output values of the fifth network are the final output values and thus represent the solution to the task of the overall network.

In this way, subnetworks can be arranged in any architecture. In particular, the architecture of the subnetworks can be adapted to the network tasks to be solved. In one embodiment, the layers of different subnetworks can be linked together to exchange information between the subnetworks.

According to an example embodiment of the present invention, for each task, i.e., for each subnetwork, a loss function is defined. The loss function, also called a cost function, is a function used to quantify the deviation or error between the predicted values of a model and the actual values of the target variables. It captures the error or discrepancy between the model's predictions and the actual data points. It is a mathematical function that uses the input variables of the model to calculate the error value. The greater the error value, the greater the difference between the model's predictions and the actual values.

The choice of loss function depends on the type of problem to be solved. There are different types of loss functions that have been developed for different scenarios and applications.

The mean squared error (MSE) is often used in regression problems. It calculates the mean squared error between the predicted and actual values.

Binary cross-entropy is used in binary classification problems. It quantifies the error between the predictions and the actual binary labels.

Categorical cross-entropy is used in multiclass classification problems. It measures the error between the predictions and the actual class labels.

The log loss function is often used in probabilistic models in which the predictions are interpreted as probabilities. It calculates the logarithmic error between the probabilities and the actual values.

The goal during training is to minimize the loss functions of the different tasks. This is usually achieved by adjusting the weights and parameters of the model using optimization algorithms such as gradient descent. By minimizing the loss functions, the model can learn to make more accurate predictions and achieve a better fit to the given data.

The choice of the appropriate loss function is crucial because it directly affects the nature of the task at hand and the type of outputs of the model. In order for the network to be able to solve its higher-level task, the loss functions must be combined to form an overall loss function. Typically, weighting factors are used to assign a weight to the individual tasks which in some way reflects the relevance of the particular task in solving the overall task of the network. For example, important tasks can have a higher weight than unimportant tasks. Alternatively, more difficult tasks can have a higher weight than easy tasks, where difficult and easy can be measured by how many epochs a subnetwork needs until it solves its task sufficiently well.

According to an example embodiment of the present invention, the weighting factor for each task is treated as a trainable parameter. The weighting factor can take values between 0 and 1. However, the sum of all weighting factors must be 1. This ensures that the network does not weight any of the tasks as overly relevant.

Thanks to the trainable weighting factor, the network can adjust itself during training to determine which weight should be assigned to which task. In particular, the trainability of the weighting factor enables the network to be scalable with all its tasks. The weighting factors are adjusted automatically when the network is trained, so that manual distribution of the weighting factors can be done without. The present invention thus solves the underlying problem.

However, it could happen that a network sets the weighting factor for the task with the lowest loss function to 1 and makes all other tasks irrelevant with a weighting factor of 0. To prevent this, a regulating term is provided which becomes very large for the extreme values of the weighting factor. This means that in an overall loss function, the large regulating terms would counteract the particularly low or particularly high weighting factors. This can prevent the scenario in which one or a few weighting factors are set to 1 or close to 1 and all other weighting factors are set to 0.

Such a regulatory term or part of a regulatory term could comprise, for example:

$${R}_{1} ( {α}_{t} ) = \frac{1}{- {α}_{t} log ( {α}_{t} )} .$$

R₁ becomes infinite for

$${lim}_{α \to 0} \frac{1}{{α}_{t}}$$

and for

$${lim}_{α \to 1} \frac{1}{- log {α}_{t}}$$

and thus fulfills the condition of the present invention, where αₜ is the weighting factor of the respective task.

Another example of a regulatory term or part of a regulatory term could comprise a quadratic deviation:

$${R}_{2} ( {α}_{t} ) = {( {α}_{t} - \frac{1}{T} )}^{2} .$$

Here, T is the number of tasks in the network, so that given uniformly distributed weighting factors

$${α}_{t} = \frac{1}{T}$$

the regulating term R₂ is zero and becomes larger for other values the further they deviate from the uniform distribution. In one embodiment, the determined weighting factor is equal to the reciprocal of the number of tasks.

In one example embodiment of the present invention, the regulating term can comprise multiple components, in particular the terms R₁ and R₂.

In one example embodiment of the present invention, the regulating term can comprise a hyperparameter that controls the amount of regulation. In particular, the hyperparameter can have the same value for all tasks.

Hyperparameters are parameters that control the configuration and behavior of a model but are not learned directly from the training data. In contrast to the weights and parameters of a model, which are optimized during training, hyperparameters are set before the training process and influence the way in which the model learns and generalizes.

Hyperparameters are crucial to the performance and behavior of a learning algorithm and can control various aspects of the model and the training process.

In one example embodiment of the present invention, the total loss function L can be defined as:

$$L = {\sum }_{t} {α}_{t} {σ}_{t} {l}_{t} + μ R ( {α}_{t} )$$

with σₜlₜ as the weighted loss function of the individual tasks and μ as the hyperparameter of the regularization term.

In one example embodiment of the present invention, the loss functions of each task are different loss functions.

Advantageously, the loss function can thus be adapted to different tasks.

In one example embodiment of the present invention, the data are multidimensional data from an imaging sensor. Imaging sensors can in particular be LIDAR/LADAR or radar sensors, cameras for the visual, infrared, and/or ultraviolet spectrum, ultrasonic or motion sensors, or a combination of the above-mentioned sensors.

Multidimensional data can have more noise than one-dimensional data. Extracting the actual signal from the noise can be divided into multiple tasks that can be performed by dedicated subnetworks. Advantageously, any number of such tasks can be incorporated into a network, since the weighting factors are trained with the network.

In one example embodiment of the present invention, the network is a network for controlling an autonomous robot or vehicle.

The navigation of autonomous systems in an environment that can only be controlled to a limited extent, especially when shared with humans, can place high demands on the controlling network. A network can better meet these requirements if it divides navigation into many tasks that are handled by highly specialized subnetworks. In principle, completely separate networks could also be used to handle the large number of tasks. However, autonomous navigation must be performed by the vehicle or robot using on-board means, so that duplicate tasks would tie up valuable computing resources. Preparatory tasks, such as image processing, can be shared between the subnetworks. The navigation tasks then performed, including any control of the system, can be processed vertically, horizontally, or in combination.

In one example embodiment of the present invention, the network is a network for routing vehicular traffic.

A neural network trained with MTL for traffic control in a city offers multiple advantages compared to conventional training methods. Since traffic control involves various aspects such as traffic prediction, vehicle detection, and traffic light control, MTL can efficiently utilize the available data and provide a more comprehensive understanding of urban traffic dynamics. By learning multiple tasks simultaneously, the model can develop a more general understanding of the underlying features that are important for traffic control. This improves the model's ability to generalize to new, unknown traffic situations, because it gains more comprehensive knowledge about different aspects of traffic. By training tasks together, the model can benefit from synergy effects. For example, understanding traffic forecasting can help control traffic lights more effectively. These synergy effects can lead to improved overall performance of the model.

Furthermore, in many practical scenarios, access to sufficiently labeled data for each individual task may be limited. MTL can help overcome this bottleneck by sharing information between tasks, thereby reducing the need for large amounts of specific training data for each task. This allows the model to learn even with limited amounts of data and still regulate traffic safely.

In one example embodiment of the present invention, the network is a network for controlling a household appliance.

A neural network trained with MTL for controlling a household appliance such as a food processor or a robot vacuum cleaner offers multiple advantages compared to conventional training methods. Household appliances often have different functions and tasks that are interrelated and are based on shared domain knowledge. MTL makes it possible to use this domain knowledge more effectively by sharing it between tasks. Through joint training, the model can develop a more comprehensive understanding of the underlying domain and thus improve performance in controlling the household appliance. Home appliances often require complex tasks that combine different aspects, such as object detection, motion control, sensor integration, etc. MTL allows the model to learn and integrate multiple aspects simultaneously. This leads to a more holistic approach to controlling household appliances, as the model combines various capabilities and tasks in a single model.

In one example embodiment of the present invention, the network is a network for processing language.

A neural network trained with MTL for processing language results in multiple advantages compared to conventional training methods. MTL allows training on multiple language-related tasks simultaneously by sharing common information and patterns between tasks. Since language processing involves various aspects such as machine translation, speech recognition, and text classification, MTL can efficiently utilize the available data and enable a more comprehensive understanding of the language.

By training multiple language-related tasks together, the model can develop a more general understanding of the underlying linguistic features. By learning different linguistic aspects, it can generalize better to different linguistic inputs and tasks. For example, understanding syntax in machine translation can also be useful in text classification. These synergistic effects can lead to improved performance and robustness of the model.

The aforementioned example embodiments have in common that they are scalable through the use of automatically trained weighting factors and that no weighting factors have to be set manually or by means of a heuristic.

In an example embodiment of the present invention, the optimization method for the overall loss function comprises training the weighting factors, wherein the training of the weighting factors is a task of the network.

In these example embodiments of the present invention, the network comprises a sub-network whose task is to train the weighting factors. By incorporating a subnetwork responsible for training the weighting factors, the weighting factors can be better determined. The subnetwork has this task exclusively, so it can concentrate on this task alone.

In one example embodiment of the present invention, the optimization method comprises training the weighting factors using a standalone neural network.

In one example embodiment of the present invention, the last layer converts the output values of the penultimate layer into a probability distribution in order to ascertain the weighting factors. In particular, a softmax function can be used.

A softmax is a mathematical function used to generate probability distributions across multiple classes. It can be used as an activation function in the output layer of a classification network. The softmax function takes a vector of real numbers as input and transforms it into a vector of probabilities, where the sum of all probabilities is 1. This is particularly useful in multi-class classification problems in which the network must decide which class a given input pattern most likely belongs to.

The softmax function amplifies large values and attenuates small values. This emphasizes the differences between the input values and adjusts the probabilities for the different classes. Larger input values have a larger exponential component and therefore contribute more to the total, resulting in higher probabilities.

The softmax function has the advantage that it makes the output of the neural network interpretable. The resulting probabilities can be used as confidence values or confidence levels for the different classes, which is helpful in decision making or evaluating the network output.

In one example embodiment of the present invention, the optimization method comprises deriving the weighting factors from factors of the network or the output of the network.

For example, the quotient of the loss function of a single task and the loss function at a previous time unit or the development of weights of the network can be formed, which is then optimized when executing the optimization method.

The total loss function L could then be defined for two consecutive epochs as, for example:

$$L = {\sum }_{i = 1}^{K} \frac{K {e}^{( \frac{{L}_{{i}_{t - 1}}}{{L}_{{i}_{t - 2}}} / T )}}{{\sum }_{j = 1}^{K} {e}^{( \frac{{L}_{{i}_{t - 1}}}{{L}_{{i}_{t - 2}}} / T )}} {L}_{i} .$$

With such a definition, the total loss function can be ascertained dynamically and without a history or with a very limited history.

Furthermore, the hyperparameter T can be taken into account in the softmax function by ascertaining the weighting factor via:

$$α = Softmax ( \frac{[ {w}_{1} , {w}_{2} ]}{T} ) with \\ {w}_{1} = \frac{{L}_{{1}_{t - 1}}}{{L}_{{1}_{t - 2}}} and {w}_{2} = \frac{{L}_{{2}_{t - 1}}}{{L}_{{2}_{t - 2}}} .$$

Advantageously, such a combination maintains the converging behavior of the overall loss function as well as the focus on difficult tasks during training.

In one example embodiment of the present invention, the network is trained in multiple epochs, with the influence of the weighting factors decreasing over the epochs.

Advantageously, a decrease in the influence of the weighting factors means that the network can concentrate more on the difficult tasks at the beginning and towards the end of the training the tasks are again trained together with “equal value.”

For example, the overall loss function can comprise a reduction term that reduces the influence of the weighting factors as the training epochs increase.

The total loss function in such an embodiment could then look like this:

$$L = {\sum }_{t} ( r {α}_{t} {σ}_{t} {l}_{t} + ( 1 - r ) {σ}_{t} {l}_{t} ) + r μ R ( {α}_{t} )$$

The total loss function is therefore made up of two parts. The first term rαₜσₜlₜ decreases over time. The second part (1−r)σₜlₜ, in contrast, increases over time. In the embodiment shown, the regulating term R is also provided with the reduction term, so that the regulation also decreases over time.

For example, the descent can occur linearly from 1 to 0 over all or a portion of the epochs. Alternatively, the descent can be set in stages. For example, in epochs 0 to 10, r could be 1, then in epochs 20 to 100 r=0.6, . . . , and in epochs 250+, r=0. Another alternative is to let r fall off exponentially.

In a further aspect, the present invention relates to a computer program with program code for carrying out a method for training a neural network of the present invention as described above when the computer program is executed on a computer.

In a further aspect, the present invention relates to a computer-readable data carrier with program code of a computer program for carrying out a method for training a neural network of the present invention as described above when the computer program is executed on a computer.

In a further aspect, the present invention relates to a system for training a neural network according to one of the above-described embodiments, wherein the system is designed to carry out a method as described above.

The described example embodiments and developments can be combined with one another as desired.

Further possible example embodiments, developments and implementations of the present invention also include combinations not explicitly mentioned of features of the present invention described above or in the following relating to the exemplary embodiments.

### BRIEF DESCRIPTION OF THE DRAWINGS

The figures are intended to impart further understanding of the example embodiments of the present invention. They illustrate embodiments and, in connection with the description, serve to explain principles and concepts of the present invention.

Other embodiments and many of the mentioned advantages are apparent from the figures. The illustrated elements of the figures are not necessarily shown to scale relative to one another.

FIG. 1 schematically shows the sequence of the training of a neural network according to one example embodiment of the present invention.

FIG. 2 shows a neural network with a vertical task structure

FIG. 3 shows a neural network with a combined task structure.

In the figures, identical reference signs denote identical or functionally identical elements, parts or components, unless stated otherwise.

### DETAILED DESCRIPTION OF EXAMPLE EMBODIMENTS

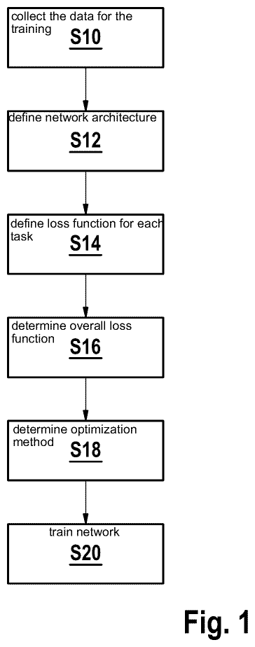

FIG. 1 schematically shows the sequence of training a neural network having multiple tasks according to an embodiment.

In step S10, data are collected for the training. The collection of data can involve the recording or creation of data. In the next step S12, the network architecture is defined. The tasks of the network are extracted, and subnetworks are arranged horizontally, vertically, or in combination so as to suit the tasks.

In step S14, for each task a loss function is defined which is used to determine the quality of the subnetworks. However, since the network can only be trained as a whole, in step S16 an overall loss function is determined with which the work of the network as a whole can be quantified and evaluated.

Finally, in step S18 an optimization method is determined. For example, the optimization method can determine that the weighting factors decrease over time. Furthermore, it can be determined to what extent the regulating term should be included in the overall loss function. For this purpose, the value of a corresponding hyperparameter is determined.

Finally, the network is trained in step S20, which comprises an iterative process in which the overall loss function is minimized, and in step S22 the neural network is provided.

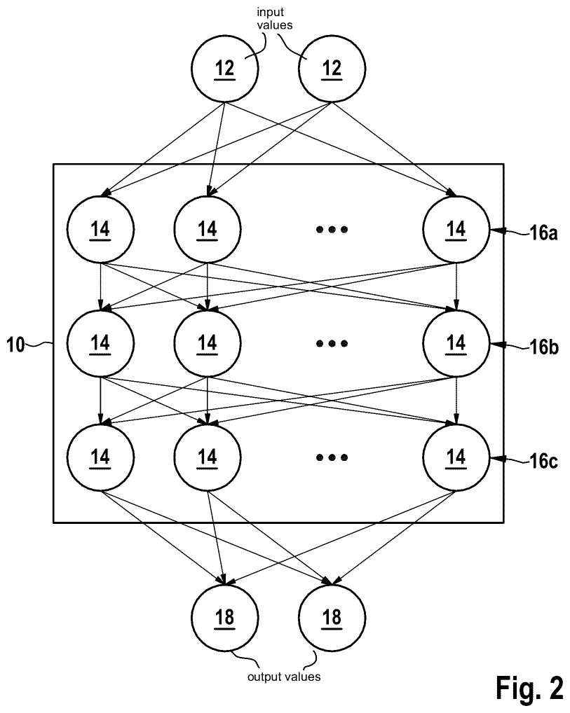

FIG. 2 shows, by way of example and schematically, the structure of a neural network 10. The network 10 receives two values 12 as input values. In other embodiments, a network 10 can receive significantly more values as input. For example, the input values 12 for a network 10 can comprise an image with two spatial dimensions and three color channels, which corresponds to a number of pixels of the image times three, one value for each color channel. The networks 10 shown in the context of the present invention are intended only to illustrate the basic structure of the networks and not to limit the present invention.

The input values 12 are processed by nodes 14, which are arranged in multiple layers 16b, 16c. Each layer is responsible for its own task. Since layers 16a, 16b, and 16c each receive the output values of the previous layer as input values, layers 16a, 16b, and 16c are arranged vertically. The last layer 16c provides the output values 18 with which the overall task of the network 10 is solved.

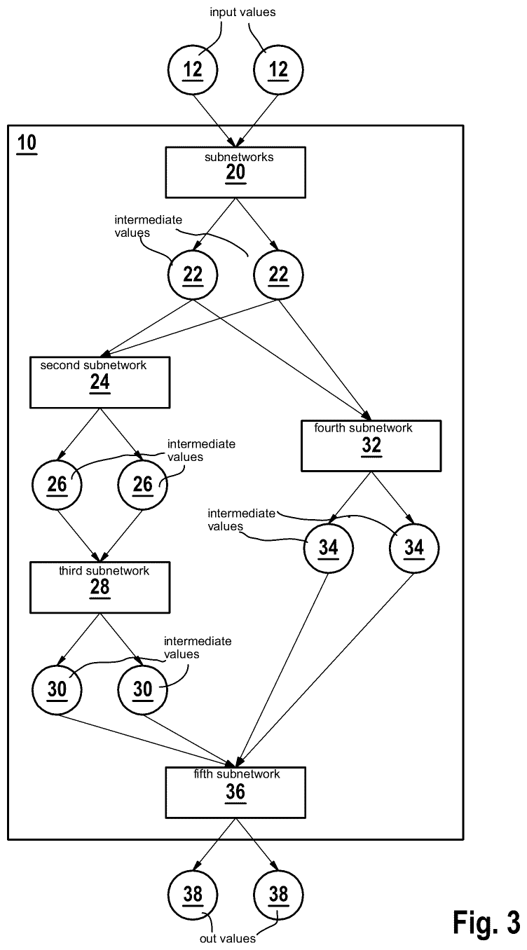

FIG. 3 also shows an exemplary and schematic structure of a network 10 that is more complex than the network 10 in FIG. 2.

The network 10 in FIG. 3 comprises 5 subnetworks. Each subnetwork can contain one or more layers with multiple neurons.

The input values 12 are entered into a first subnetwork 20. The subnetwork 20 performs general operations on the input values 12 and generates the intermediate values 22. These intermediate values 22 are used as input values for a second subnetwork 24, which in turn generates intermediate values 26. These intermediate values 26 are used as input values for a third subnetwork 28, which in turn generates intermediate values 30.

A fourth subnetwork 32 operates in parallel to the operations of the second subnetwork 24 and the third subnetwork 28. The fourth subnetwork, like the second subnetwork 24, receives the intermediate values 22 from the first subnetwork 20 as input values. The fourth subnetwork 32 generates intermediate values 34.

The fourth subnetwork 32 operates in parallel to the second subnetwork 24 and the third subnetwork 28. Thus, a horizontal network structure exists between the second subnetwork 24 in connection with the third subnetwork 28 and the fourth subnetwork 32.

A fifth subnetwork 36 receives as input values the intermediate values 30 of the third subnetwork 28 and the intermediate values 34 of the fourth subnetwork 32. From these input values, the fifth subnetwork 36 generates the output values 38, which solve the task of the overall network 10. The subnetworks 20, 24, 28, 32, on the other hand, solve only partial tasks, which are combined with the fifth subnetwork 36 to form an overall solution.

The overall loss function would be made up of the loss functions of the subnetworks 20, 24, 28, 32, 36, each multiplied by a weighting factor.

What is claimed is:

1. A computer-implemented method for training a neural network, wherein the network performs multiple tasks and is trained to solve the tasks, the method comprising the following steps:
collecting data as input values for the network;
defining a network architecture for the network including multiple subnetworks, wherein each of the subnetworks performs a respective task;
defining a loss function for each respective task;
determining an overall loss function that summarizes respective loss functions of each of the respective tasks;
determining an optimization method for the overall loss function;
training the network, wherein the training includes minimizing the overall loss function, and wherein the minimization of the overall loss function is carried out according to the optimization method; and
providing the neural network;
wherein the overall loss function includes a trainable weighting factor and a regularization term for each loss function,
wherein the sum of the weighting factors is 1,
wherein the regularization term is minimal for a a given weighting factor, and wherein the regularization term is larger for weighting factors larger than the given weighting factor, and wherein the regularization term is larger for weighting factors smaller than the given weighting factor.

2. The computer-implemented method according to claim 1, wherein the data are multidimensional sensor data of an imaging sensor.

3. The computer-implemented method according to claim 1, wherein the network is a network for controlling an autonomous robot or vehicle.

4. The computer-implemented method according to claim 1, herein the network is a network for routing vehicle traffic.

5. The computer-implemented method according to claim 1, wherein the network is a network for controlling a household appliance.

6. The computer-implemented method according to claim 1, wherein the network is a network for processing language.

7. The computer-implemented method according to claim 1, wherein the optimization method for the overall loss function includes training the weighting factors, wherein the training of the weighting factors is a task of the network.

8. The computer-implemented method according to claim 1, wherein the optimization method includes training the weighting factors using an independent neural network.

9. The computer-implemented method according to claim 1, wherein a last layer of the network converts output values of a penultimate layer of the network into a probability distribution for ascertaining the weighting factors.

10. The computer-implemented method according to claim 1, wherein the optimization method includes deriving the weighting factors from factors of the network or from output of the network.

11. The computer-implemented method according to claim 1, wherein the training of the network takes place in multiple epochs, wherein an influence of the weighting factors decreases over the epochs.

12. A non-transitory computer-readable data carrier on which is stored program code of a computer program for training a neural network, wherein the network performs multiple tasks and is trained to solve the tasks, the program code, when executed by a computer, causing the computer to perform the following steps:
collecting data as input values for the network;
defining a network architecture for the network including multiple subnetworks, wherein each of the subnetworks performs a respective task;
defining a loss function for each respective task;
determining an overall loss function that summarizes respective loss functions of each of the respective tasks;
determining an optimization method for the overall loss function;
training the network, wherein the training includes minimizing the overall loss function, and wherein the minimization of the overall loss function is carried out according to the optimization method; and
providing the neural network;
wherein the overall loss function includes a trainable weighting factor and a regularization term for each loss function,
wherein the sum of the weighting factors is 1,
wherein the regularization term is minimal for a a given weighting factor, and wherein the regularization term is larger for weighting factors larger than the given weighting factor, and wherein the regularization term is larger for weighting factors smaller than the given weighting factor.

13. A system for training a neural network, for training a neural network, wherein the network performs multiple tasks and is trained to solve the tasks, the system configured to:
collect data as input values for the network;
define a network architecture for the network including multiple subnetworks, wherein each of the subnetworks performs a respective task;
define a loss function for each respective task;
determine an overall loss function that summarizes respective loss functions of each of the respective tasks;
determine an optimization method for the overall loss function;
train the network, wherein the training includes minimizing the overall loss function, and wherein the minimization of the overall loss function is carried out according to the optimization method; and
provide the neural network;
wherein the overall loss function includes a trainable weighting factor and a regularization term for each loss function,
wherein the sum of the weighting factors is 1,
wherein the regularization term is minimal for a a given weighting factor, and wherein the regularization term is larger for weighting factors larger than the given weighting factor, and wherein the regularization term is larger for weighting factors smaller than the given weighting factor.
